(19) United States
(12) Patent Application Publication
(10) Pub. No.: US 2026/0316131 A1
(43) Pub. Date: Oct. 15, 2026

(54) System and Method for Applying Electric Fields Into the Subsoil, in Particular for Reclamation and Requalification of Contaminated Sites

(71) Applicant: Politecnico Di Torino, Torino (TO) (IT)

(72) Inventors: Rajandrea Sing Sethi, Torino (IT); Carlo Bianco, Torino (IT)

(21) Appl. No.: 19/482,838

(22) PCT Filed: Apr. 16, 2024
(86) PCT No.: PCT/IB2024/053699

§ 371 Date: Nov. 10, 2025

(30) Foreign Application Priority Data
May 11, 2023 (IT) 102023000009432

(51) Int. Cl. B09C 1/08; E02D 3/11

(52) U.S. Cl. CPC B09C 1/085; E02D 3/11; B09C 2101/00

(57) ABSTRACT

A system and a method for applying electric fields into the subsoil, in particular for reclamation and requalification of contaminated sites, include: a conductive element arranged in a drilling made in a subsoil portion; a first electrically conductive material suitable for filling a gap generated between an outer wall of the conductive element and an inner wall of the drilling, so that the conductive element is at least partly in electric contact with the first electrically conductive material; a second electrically conductive material suitable for being injected into the subsoil portion so as to be in electric contact with the conductive element and with the first electrically conductive material; a component suitable for supplying electric energy to the conductive element in order to generate a hydraulic field between the conductive element and one or more subsoil portions located around the drilling.

### BACKGROUND OF THE DISCLOSURE

### 1. The Field of the Disclosure

The present invention relates to a system and a method for applying electric fields into the subsoil, in particular for reclamation and requalification of contaminated sites.

### 2. The Relevant Technology

In the context of reclamation and requalification of contaminated sites, the application of an electric field into the subsoil offers many opportunities to develop innovative technological approaches aimed at making the pollutant removal or transformation process more effective and sustainable.

Applications studied so far include:
electrokinetic methods for facilitating the removal of ionic pollutants such as heavy metals, radionuclides and polar or ionizable organic pollutants: pollutants contained in the aquifer system migrate, due the effect of the electric field, towards the electrode with opposite charge; when the pollutants reach the electrode, they are immobilized in situ by means of processes of electrodeposition, precipitation or co-precipitation on the electrode's surface, or removed by pumping water by means of draining systems installed in close vicinity;
electrokinetic methods for facilitating groundwater distribution of ionic amendments/reagents necessary for the application of in situ reclamation technologies like In Situ Chemical Oxidation (ISCO) and Enhanced Reductive Dechlorination (ERD): reagents are dosed into the subsoil in proximity to the electrode with homogeneous charge, and migrate towards the electrode with opposite charge due to the effect of the electric field or due to the combined effect of the hydraulic motion field and the electric field;
bioelectrochemical methods for supporting biological removal (bioremediation) processes for removal of organic and inorganic pollutants (e.g., hydrocarbons, pharmaceutical products, nitrates): the electric field acts as an inexhaustible electron donor/acceptor supporting bacteria-mediated pollutant oxidoreduction processes, thereby eliminating the need for (continuous) external addition of chemical amendments, resulting in a more sustainable reclamation process;
electrochemical methods for supporting direct production in the subsoil of species reactive with contaminants, such as, for example, electro-fenton processes, wherein the electric field is used in order to generate hydroxyl and/or peroxide radicals causing catalytic oxidation of pollutants.

Another example is the electro-assisted production of reactive nanomaterials directly in the subsoil, as described in document no. WO 2020/084378 in the name of the inventors of the present invention: metal precursors and reductants are injected into the subsoil and, as they mix together in the subsoil, induce the formation of microparticles or nanoparticles reactive with pollutants. The preliminary application of an electric field, during and after reagent injection, establishes optimal conditions for reducing the metal precursors, thus promoting the formation of reactive particles.

A first problem concerning the application of electric fields into the subsoil relates to the high electric resistance of the electrode-soil system, which may imply a reduction in the range of influence of the electric field, heterogeneous current distribution in the subsoil, and increased energy consumption required for reclaiming the site. With the same applied voltage, the current intensity circulating in the subsoil will depend, in fact, on the electric resistance of the electrode-soil system. The higher the system's resistance, the less current will circulate, the supplied power being equal.

From a technical point of view, the resistance of the electrode-soil system can be schematized as a graphical representation of conduction paths of an electric current in a subsoil, shown in FIG. 1a, and as an equivalent circuit, shown in FIG. 1b, wherein the two in-series resistors 10 and 11 represent, respectively, the intrinsic resistance of the electrode and the contact resistance between the electrode and the soil, while the three parallel resistors 12, 13 and 14 represent the three main paths of electric current conduction in the subsoil, i.e.: i) conduction through the mineral matrix that constitutes the soil; ii) surface conduction due to the presence of a diffuse double layer on the surface of the mineral matrix that constitutes the soil; iii) conduction through a fluid (water or air) that fills the pores of the soil.

By analyzing the contributions of the individual resistors 10,11,12,13,14, the following remarks can be made:
since electrodes are normally made of highly conductive materials, the electrode's resistance 10 is typically much lower than that of the other elements and can be disregarded;
the contact resistance 11 between the electrode and the soil is strongly dependent on the electric conductivity of the medium in contact with the electrode (soil and/or water and/or air) and on the contact area, and may be rather high for an electrode driven into unsaturated gravelly soil;
the soil typically consists of non-conductive minerals; therefore, the electric resistance 12 of the mineral matrix is typically very high, and no significant current circulation is observed through the solid soil matrix;
surface conduction 13 normally gives a non-negligible contribution in clayey soils, where the diffuse double layer participates considerably in electron transport, while, on the contrary, surface resistance is very high in rough soils characterized by high hydraulic conductivity, small specific area and negligible clay content, significantly limiting the circulation of current through this path;
the resistance 14 is highly dependent on the type of fluid that fills the pores of the soil: in unsaturated soils, the filling fluid is air, which is the insulating agent par excellence; in aquifer systems, the filling fluid is water, the electric conductivity of which depends on its dissolved salt content.

It follows, therefore, that the equivalent resistance of the electrode-soil system, and hence the efficiency of the electro-assisted reclamation process, is strongly dependent on the granulometry and mineralogy of the solid matrix that constitutes the soil, on soil porosity, on the type of fluid circulating in the pores, and on the efficiency of the coupling between the electrode and the soil.

The worst condition is observed in unsaturated soil with high granulometry (e.g., gravel or sand with air-filled pores), in which condition equivalent resistance is highest. In a saturated medium, the presence of water in the pores leads to a reduction in the electric resistance of the system, compared with the unsaturated case. However, since electric conductivity of groundwater is typically low (less than 150 μS/cm) because of its low dissolved salt content, it is often necessary to resort to continuous injection of highly concentrated saline solutions in order to attain a significant circulation of current within the system.

A second problem concerning the application of reclamation techniques aided by electric fields is related to the need for simultaneously injecting and/or extracting fluids into/from the subsoil. Many reclamation approaches envisaging the application of an electric field also require, in fact, simultaneous injection/extraction of fluids (e.g., contaminated water, reagents, amendments) in order to achieve/support pollutant removal.

Typically, fluids are handled by means of conventional techniques, e.g., extraction/injection wells, valved pipes, or direct-push systems, while the electric field is applied by means of pairs of electrodes driven into the subsoil near the draining/injection systems. This non-coincidence between the position of the electrode and the fluid injection/extraction point typically causes an offset between electric flux lines (which converge towards the electrode) and hydraulic flux lines (which converge towards the injection/extraction point), resulting in reduced pollutant/reagent transport efficiency.

The use of electric fields to support reclamation interventions is a relatively recent approach. At present, therefore, not many technologic solutions are available on the market for solving the above-described problems. Some existing solutions are derived, as a matter of fact, from fields of application not related to reclamation of contaminated sites (e.g., grounding of electric systems, geophysics), and are not, therefore, optimal for this purpose.

With reference to FIGS. 2a,2b,2c,2d, the following will illustrate the main technical solutions according to the state of the art:
A. Electrode in wells/piezometers (FIG. 2a): the electrode 4 is directly introduced at the fluid injection/extraction point. In this configuration, electric flux lines (from electrode to electrode) and hydraulic flux lines (radial relative to the injection/extraction point) coincide, maximizing the velocity of migration of pollutants/reagents. However, this approach is not applicable to unsaturated soil, because current can only flow by conduction in the liquid contained in the well (groundwater or specially injected saline solution). Moreover, electrode contact resistance and electric field propagation within the aquifer system are strongly affected by the hydrochemical characteristics of the fluid inside the well and of the groundwater, and it is often necessary to continuously inject concentrated saline solutions in order to attain a significant circulation of current within the system.
B. Approach described in patent U.S. Pat. No. 5,398,756 for the formation of horizontal electrodes in the subsoil (FIG. 2b): conductive granular material is injected into the subsoil by hydraulic fracturing; the material is distributed within a fracture in the subsoil, creating a layer a few centimeters thick with high electric conductivity; an electrode 4 made of conductive material is then driven into the soil to the depth of the fracture, thus coming in contact with the conductive material. This approach makes it possible to distribute the electric field very far from the electrode through fractures filled with conductive material. Nevertheless, the small contact area between the electrode and the conductive material (just a few cm) results in high contact resistance. Furthermore, the fractures created by hydraulic fracturing are typically very thin (just a few cm), and their actual position and spatial orientation within the aquifer cannot be predicted a priori. Therefore, the reduction obtained in the electric resistance of the soil is very local and difficult to control. Lastly, the point of fluid injection/extraction and the point of application of the electric field, and hence the hydraulic and electric flux lines, do not coincide.
C. Electrode buried in conductive material (FIG. 2c): a drilling 1 or trench is excavated in the subsoil, into which one or more electrodes 4 are introduced; the gap in the drilling 1 is then filled with conductive material like coal, iron or clay. This approach reduces contact resistance at the electrode but does not contribute to reducing the electric resistance of the soil, so that the range of influence of the electric field is typically limited. Moreover, this approach does not allow for simultaneous injection/extraction of fluids at the same point where the electric field is applied.
D. Injection of zerovalent iron nanoparticles as illustrated in document no. EP3895817A1 (FIG. 2d): the electrode 4 is driven directly into the soil; subsequently, zerovalent iron nanoparticles are injected through an injection point located near the electrode in order to locally reduce the electric resistance of the soil. This approach has no direct effect on electrode-soil contact resistance, in that it cannot ensure that the nanoparticles will actually come in contact with the electrode or part thereof. In addition, it cannot ensure that the particles will be actually distributed around the electrode 4, leading to a real increase of the electrode's range of influence. Lastly, the fluid injection/extraction point and the point of application of the electric field do not coincide.

### SUMMARY OF THE DISCLOSURE

It is therefore one object of the present invention to propose a system and a method for applying electric fields into the subsoil, in particular for reclamation and requalification of contaminates sites, which can provide increased local electric conductivity of the soil and which can minimize the electrode-soil contact resistance in order to improve the distribution of electric fields in the subsoil.

It is another object of the present invention to propose a system and a method for applying electric fields into the subsoil, in particular for reclamation and requalification of contaminated sites, which can increase the range of influence of the electrodes.

It is a further object of the present invention to propose a system and a method for applying electric fields into the subsoil, in particular for reclamation and requalification of contaminated sites, which can reduce the energy consumption of the reclamation process.

It is yet another object of the present invention to propose a system and a method for applying electric fields into the subsoil, in particular for reclamation and requalification of contaminated sites, which can maximize the electrokinetic and/or (bio)electrochemical effect of the reclamation process.

In brief, the present invention relates to a system for applying electric fields into the subsoil, in particular for reclamation and requalification of contaminated sites, which comprises a conductive element arranged in a hole drilled in a subsoil portion; a first electrically conductive material adapted to fill a gap generated between an outer wall of the conductive element and an inner wall of the drilling, so that the conductive element is at least partly in electric contact with the first electrically conductive material; a second electrically conductive material adapted to be injected into the subsoil portion so as to be in electric contact with the conductive element and with the first electrically conductive material; means adapted to supply electric energy to the conductive element for the purpose of generating an electric field between the conductive element and one or more subsoil portions situated around the drilling.

In one embodiment of the system according to the invention, the injection and/or extraction means comprise a tubular device, which can be inserted, whether temporarily or permanently, into the drilling, and which is equipped with first opening means adapted to inject the second electrically conductive material into the subsoil portion and/or adapted to inject and/or extract fluids, muds and/or colloidal suspensions into/from said subsoil portion. In one embodiment of the system according to the invention, injection and/or extraction means are employed which comprise a hollow conductive element provided with second opening means adapted to inject the second electrically conductive material into the subsoil portion and/or adapted to inject and/or extract fluids, muds and/or colloidal suspensions into/from said subsoil portion.

In one embodiment of the system according to the invention, the injection and/or extraction means comprise at least one non-return suitable for preventing a backflow of the second electrically conductive material towards the injection and/or extraction means.

In one embodiment of the system according to the invention, the conductive element is at least partly made of one or more of the following electrically conductive materials: metals, in particular steel, iron, copper or graphite; carbon materials; conductive polymers; conductive fabrics; conductive cements.

In one embodiment of the system according to the invention, at least one longitudinal portion of the conductive element comprises an electrically non-conductive material.

In one embodiment of the system according to the invention, the conductive element comprises first longitudinal portions comprising an electrically non-conductive material alternated with second longitudinal portions comprising an electrically conductive material.

In one embodiment of the system according to the invention, the first electrically conductive material comprises a granular material having an average grain size greater than 0.1 mm and a hydraulic conductivity greater than 10⁻⁴ m/s.

In one embodiment of the system according to the invention, the granular material of the first electrically conductive material comprises grains comprising one or more of the following materials: zerovalent iron; zerovalent copper; steel or other metals; graphite; coal; environmentally compatible conductive materials.

In one embodiment of the system according to the invention, the first electrically conductive material comprises an impermeable or poorly permeable compact material having an average grain size smaller than 10 mm and a hydraulic conductivity of less than 10⁻⁴ m/s.

In one embodiment of the system according to the invention, the impermeable compact material comprises one or more of the following materials: clay; conductive cement; coal or graphite powder; metal powders; conductive resins; environmentally compatible conductive materials.

In one embodiment of the system according to the invention, the second electrically conductive material comprises nanoparticles and/or microparticles having a size in the range of 1 nm to 10 mm, more preferably 1 nm to 100 μm.

In one embodiment of the system according to the invention, the nanoparticles and/or microparticles of the second electrically conductive material comprise one or more of the following materials: zerovalent iron; zerovalent copper; sulphides of iron or other conductive minerals or metals; graphene; graphite; coal; conductive cement.

In one embodiment of the invention, a method is proposed for applying electric fields into the subsoil, in particular for reclamation and requalification of contaminated sites, which comprises the steps of: executing a drilling into a subsoil portion; introducing a conductive element into the drilling; filling a gap generated between an outer wall of the conductive element and an inner wall of the drilling with a first electrically conductive material, so that the conductive element is at least partly in electric contact with the first electrically conductive material; injecting a second electrically conductive material into the subsoil portion, so that it is in electric contact with the conductive element and with the first electrically conductive material; supplying electric energy to the conductive element for the purpose of generating an electric field between the conductive element and one or more subsoil portions situated around the drilling.

In one embodiment of the method according to the invention, it comprises the step of introducing into the gap, whether temporarily or permanently, a tubular device having first opening means through which the second electrically conductive material is injected into the subsoil.

In one embodiment of the method according to the invention, the conductive element is hollow and is provided with second opening means through which said second electrically conductive material is injected into the subsoil portion and/or fluids, muds and/or colloidal suspensions are injected into and/or extracted from the subsoil portion.

In one embodiment of the method according to the invention, the first electrically conductive material is introduced into the drilling to form a single continuous layer, or it is introduced as multiple layers made up of different conductive materials or of conductive materials alternated with non-conductive materials, for the purpose of focusing the electric field on limited portions of the subsoil.

In one embodiment of the method according to the invention, the second electrically conductive material is either injected in particle form or synthesized directly within the subsoil upon injection of liquid and/or solid precursors.

In one embodiment of the method according to the invention, the second electrically conductive material is injected into fractures of the subsoil.

Further advantageous features of the present invention are set out in the appended claims, which are an integral part of the present description.

### BRIEF DESCRIPTION OF THE DRAWINGS

These features as well as further advantages of the present invention will become more apparent in the light of the following description of a preferred embodiment thereof as shown in the annexed drawings, provided merely by way of non-limiting example, wherein:

FIGS. 1a and 1b show, respectively, a graphic representation of conduction paths of an electric current in the subsoil and an equivalent electric circuit of an electrode-soil system;

FIGS. 2a, 2b, 2c and 2d are simplified diagrams showing prior-art technologies for the implementation of electrokinetic reclamation approaches;

FIGS. 3a, 3b and 3c show respective embodiments of a system for applying electric fields into the subsoil, in particular for reclamation and requalification of contaminated sites, according to the present invention;

FIG. 4 shows a table wherein the prior-art technologic solutions of FIGS. 2a, 2b, 2c and 2d are compared with the present invention based on parameters of interest for systems for reclamation and requalification of contaminated sites.

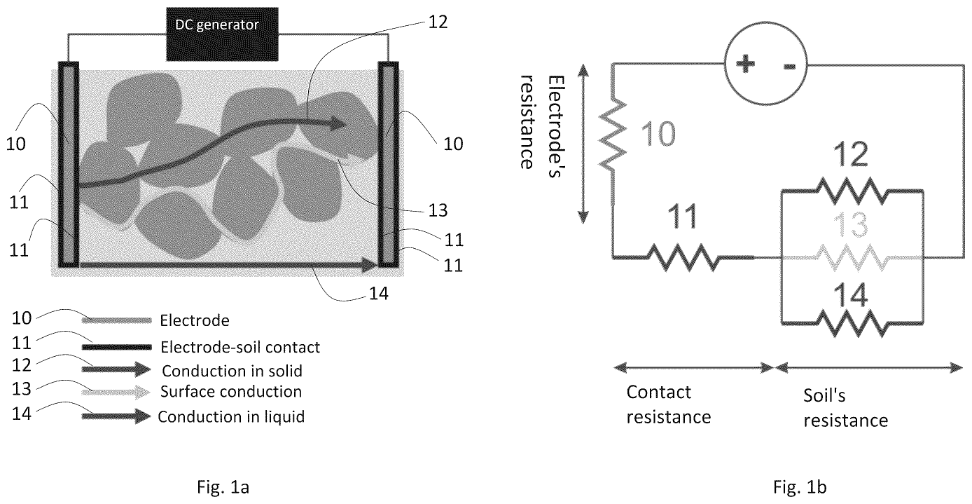

### DETAILED DESCRIPTION OF THE PREFERRED EMBODIMENTS

The following description will illustrate several specific details to facilitate an in-depth understanding of one or more exemplary embodiments of the invention. The various embodiments may also be implemented without one or more of such specific details or by using other methods, components, materials, etc. In some cases, known structures, materials or operations will not be shown or described in detail to avoid shadowing some aspects of such embodiments. In this description, any reference to an “embodiment” will indicate that a particular configuration, structure or feature described herein in relation to an embodiment is comprised in at least one embodiment of the invention. Therefore, expressions such as “in one embodiment” and the like, which may be found in different parts of this description, will not necessarily refer to the same embodiment. Moreover, any particular configuration, structure or feature may be combined as deemed appropriate in one or more embodiments.

The references below are therefore used only for simplicity's sake and shall not limit the protection scope or extension of the various embodiments.

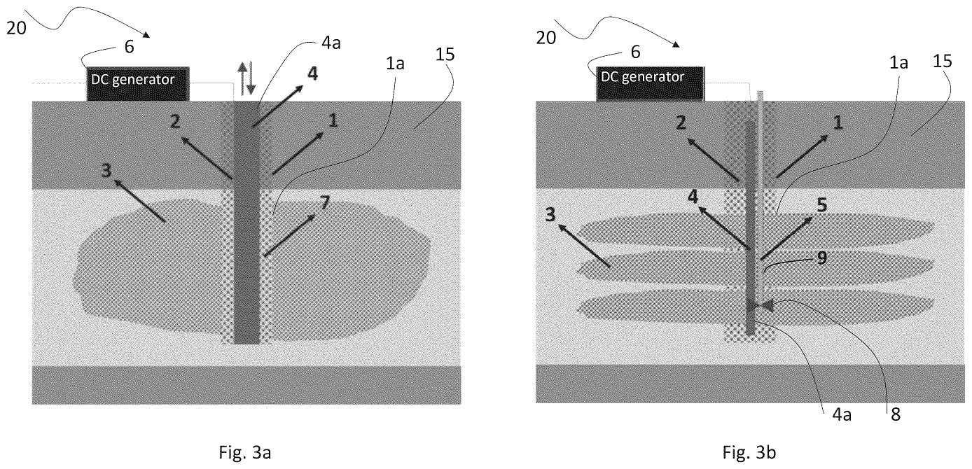

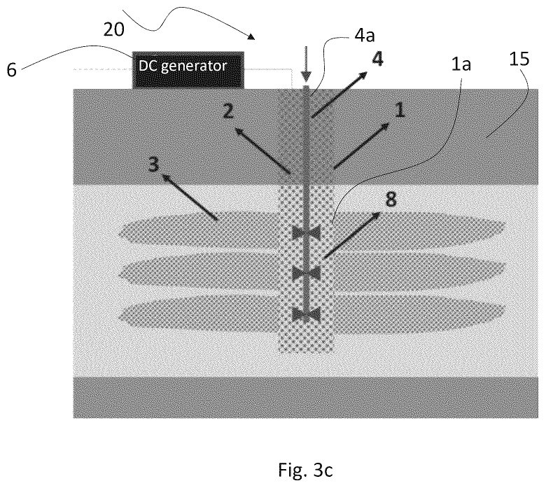

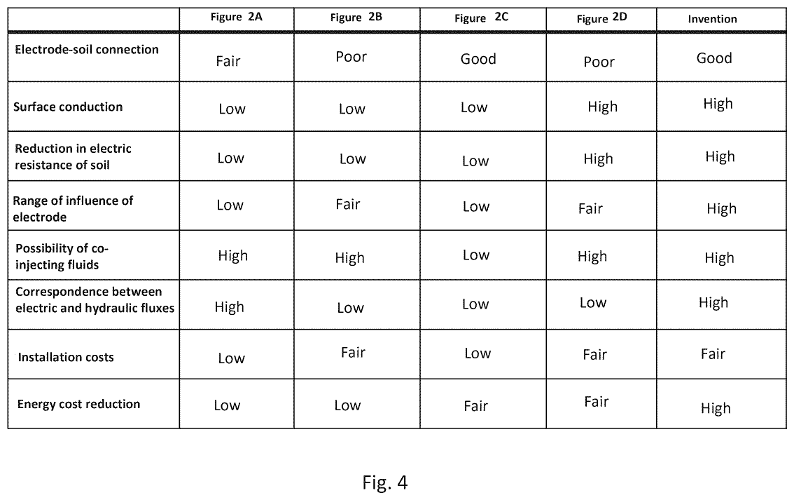

With reference to FIGS. 3a and 3b, illustrated therein is a system 20 for applying electric fields into the subsoil, in particular for reclamation and requalification of contaminated sites, which comprises: a conductive element 4 arranged in a drilling 1 in a subsoil portion 15; a first electrically conductive material 2 adapted to fill a gap generated between an outer wall 4a of the conductive element 4, e.g., an electrode, and an inner wall la of the drilling 1, so that the conductive element 4 is at least partly in electric contact with the first electrically conductive material 2; injection and/or extraction means 4,5 adapted to inject into the subsoil portion 15 a second electrically conductive material 3, so that it is in electric contact with the conductive element 4 and with the first electrically conductive material 2; means 6 adapted to supply electric energy to the conductive element 4 for the purpose of generating an electric field between the conductive element 4 and one or more subsoil portions situated around the drilling 1.

The means 6 suitable for supplying electric energy to the conductive element 4 comprise a direct and/or alternating current generator, or any other device capable of supplying electric current to the conductive element 4.

In one embodiment of the system 20, illustrated in FIG. 3a, the injection and/or extraction means comprise the conductive element 4 only, which may be hollow and provided with opening means 7, in particular holes and/or apertures, allowing for injection and/or extraction of fluids, muds and/or colloidal suspensions into the cavity of the conductive element 4 and towards a subsoil portion 15, and/or vice versa.

Alternatively, with reference to FIG. 3b, the second conductive material 3 is injected into the subsoil through a tubular device 5 introduced, whether temporarily or permanently, into the drilling 1 during or after the execution of the drilling operation. Therefore, this embodiment includes both the conductive element 4 and the tubular device 5, which is provided with additional opening means 9, such as apertures and/or holes, and which is physically distinct from the conductive element 4.

The second electrically conductive material 3 is preferably injected after the drilling 1 has been filled with the first electrically conductive material 2, so as to ensure proper mixing, and hence good electric contact, of the second electrically conductive material 3 with the first electrically conductive material 2.

With reference to FIG. 3c, the conductive element 4 may also be equipped with at least one non-return valve 8 to prevent any material that may have been injected into a subsoil portion 15 from flowing back within the conductive element 15.

In the embodiments shown in FIGS. 3a, 3b and 3c, the system 20 combines the ability of injecting/extracting fluids, muds and/or colloidal suspensions with the ability of applying electric currents into a subsoil portion 15. Furthermore, if deemed appropriate, the second electrically conductive material 3 may also be directly injected into a subsoil portion 15 through the conductive element 4.

The conductive element 4 may be made, at least partly, of electrically conductive materials, such as metals, carbon materials, conductive polymers, conductive fabrics, conductive cements, etc. Some examples of materials suitable for making the conductive element 4 are steel, iron, copper or graphite.

Should it be necessary to focus the electric field on a limited subsoil portion 15, e.g., at a certain depth, some longitudinal portions of the conductive element 4 may be made of electrically non-conductive materials, e.g., insulating plastics.

If necessary, the conductive element 4 may even be made of electrically conductive longitudinal portions alternated with electrically non-conductive longitudinal portions.

The first electrically conductive material 2 injected into the drilling 1 may be a granular material characterized by an average grain size greater than 0.1 mm and a hydraulic conductivity greater than 10⁻⁴ m/s. For example, granules of zerovalent iron, zerovalent copper, steel or other metals, graphite, coal or other environmentally compatible conductive materials may be used.

As an alternative, the first electrically conductive material 2 may be an impermeable or poorly permeable compact material characterized by an average grain size smaller than 10 mm and a hydraulic conductivity of less than 10⁻⁴ m/s. For example, clayey materials, conductive cements, coal or graphite powders, metal powders, conductive resins, or other environmentally compatible materials may be used.

The first electrically conductive material 2 may be introduced into the drilling 1 to form a single continuous layer or may be introduced as multiple layers made up of different electrically conductive materials or of conductive materials alternated with non-conductive materials, for the purpose of focusing the electric field on limited portions of the subsoil 15.

The second electrically conductive material 3 may consist of particles having a size ranging from 1 nm to 10 mm, preferably 1 nm to 100 μm. The second electrically conductive material 3 may be injected into the subsoil before, during or after the introduction of the conductive element 4 into the drilling 1. Injection may occur either just once or multiple times. Some examples of injectable conductive materials are microparticles and nanoparticles of zerovalent iron, zerovalent copper, sulphides of iron or other conductive minerals or metals, nanoparticles and microparticles of graphene or graphite, nanoparticles and microparticles of coal or conductive cement.

The second electrically conductive material 3 may be either injected in particle form or directly synthesized within a subsoil portion 15 upon injection of solid and/or liquid precursors, e.g., by using the method described in document WO 2020/084378.

The second electrically conductive material 3 may finally also be introduced through fractures (opened by using proppant) in the subsoil 15.

The present invention also relates to a method for applying electric fields into the subsoil, in particular for reclamation and requalification of contaminated sites, which comprises the steps of: executing a drilling 1 into a subsoil portion; introducing a conductive element 4 into the drilling 1; filling a gap generated between an outer wall 4a of the conductive element 4 and an inner wall 1a of the drilling 1 with a first electrically conductive material 2, so that the conductive element 4 is at least partly in electric contact with the first electrically conductive material 2; injecting, by injection means 4,5, a second electrically conductive material 3 into the subsoil portion 15, so that it is in electric contact with the conductive element 4 and with the first electrically conductive material 2; supplying electric energy to the conductive element 4 for the purpose of generating an electric field between the conductive element 4 and one or more subsoil portions situated around the drilling 1.

The advantages of the system and method according to the present invention are apparent from the above description.

In one or more embodiments of the present invention, conductive nanoparticles are injected in order to create a conductive region in the subsoil and, advantageously, to locally reduce the electric resistance of the soil, thus creating a diffuse electrode in the subsoil.

Contrary to technical solutions of prior art, the present invention combines, in one or more embodiments thereof, granular/cohesive conductive materials and conductive nanoparticles for the purpose of maximizing the efficiency of the contact between electrode and soil and, advantageously, increase the range of influence of the electric field in the subsoil.

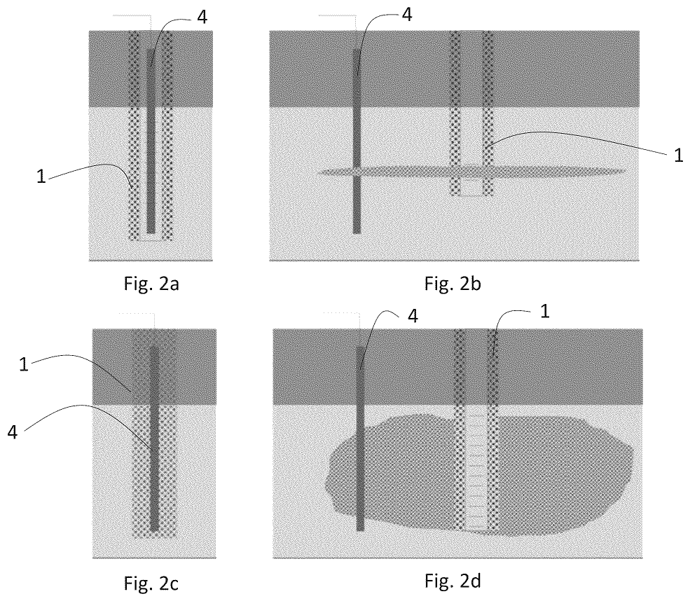

In one or more embodiments of the present invention, unlike the approach shown in FIG. 2d, conductive nanoparticles are injected into the subsoil at the very same point where the electrode has been installed and go through the granular/cohesive conductive material injected into the drilling. Advantageously. this particular mode of installation of the system ensures effective interpenetration between the granular/cohesive materials and the conductive nanoparticles within the drilling, resulting in maximized electric continuity.

In one or more embodiments, the present invention advantageously permits the use of a hollow conductor for simultaneous fluid injection/extraction and electric field application.

In one or more embodiments, the present invention makes it possible to synthesize conductive nanoparticles directly in the subsoil by exploiting the method described in document WO 2020/084378.

In one or more embodiments of the present invention, due to the fact that highly conductive materials are injected at the electrode, the contact area between the electrode and the conductive material is advantageously increased, resulting in reduced electrode-soil contact resistance.

In one or more embodiments of the present invention, the local electric resistance of the soil is reduced by injecting conductive nanomaterials into the subsoil. The nanomaterials are deposited on the surface of the solid matrix that constitutes the soil, thus significantly reducing the surface electric resistance of the soil. The nanomaterials are injected directly into the drilling filled with the first electrically conductive material, so as to ensure efficient electric contact between the first electrically conductive material and the second electrically conductive material. Advantageously, this improves the electrode-soil connection and the electrode's range of influence.

In one or more embodiments of the present invention, the “effective” area of the electrode is advantageously increased since it is extended within the subsoil by conductive materials in granular and nanoparticle form (diffuse electrode). This leads to improved distribution of electric currents in the subsoil and better reclamation results: in electrokinetic reclamation, pollutants and reagents are moved more effectively; in bioelectrochemical or electrochemical reclamation, the specific area of the electrode is increased, making for a more effective electron exchange with bacteria and/or chemical reagents.

In one or more embodiments of the present invention, thermal effects are advantageously reduced: the reduction in the overall resistance of the system leads to more moderate increases in soil temperature induced by the Joule effect, which might cause geochemical alterations of the soil and potential formation of gases and vapours in the subsoil.

In one or more embodiments of the present invention, it is advantageously possible to apply the system and method according to the invention also to unsaturated soil, in that electric current conduction does not rely entirely on the presence of water (as is the case with the approach of FIG. 2a). As a matter of fact, the improved electrode-soil connection and the reduced electric resistance of the soil ensure a good distribution of the electric field even in unsaturated soil, through the effect of improved surface conduction due to the presence of conductive nanoparticles.

In one or more embodiments of the present invention, the energy consumption and costs of the reclamation process are reduced, and the environmental sustainability of the latter is improved, because the reduction in the overall electric resistance of the system results in the same current being distributed in the subsoil with less electric power being required for supporting the reclamation process.

In one or more embodiments according to the present invention, the increased effectiveness of the treatment due to the improved distribution of the electric field in the subsoil advantageously results in less time required for reclaiming the site, with a consequent reduction in the total costs of the intervention.

In one or more embodiments according to the present invention, installation costs are reduced, and the effectiveness of the reclamation process is advantageously maximized, in that the electrode can act both as an electric field distribution point and as a fluid injection/extraction point. It is thus possible to have the electric flux lines and the hydraulic flux lines coincide, thereby maximizing the effectiveness of the reclamation process. Furthermore, installation costs can be reduced since a single drilling operation is sufficient to achieve two goals.

A comparison among the features of the prior-art systems shown in FIGS. 2a, 2b, 2c and 2d and those of the present invention, based on parameters of interest for systems for reclamation and requalification of contaminated sites, is illustrated in the table of FIG. 4. In conclusion, the Applicant executed some tests and applications in support of the development of the present invention.

Batch measurements were taken of the electric resistance of sandy porous media representative of an aquifer system in the presence and absence of conductive nanoparticles (conductive particles blended with sandy porous medium). The tests were carried out using different types of conductive particles, including metal and carbon particles. The results demonstrated that the presence of nanoparticles on the surface of sand grains can lead to an effective reduction in the electric resistance of the porous medium. Under test conditions, a lower electric resistance was observed, resulting in a reduction in supplied power for the same current, ranging between 40 and 80%.

In-flow tests were also carried out in columns packed with sandy porous media, into which conductive nanoparticles were injected. The columns were equipped with electrodes applying an electric field and measuring the electric resistance of the system. Resistance was measured before and after nanoparticle injection. In this case as well, a significant reduction in electric resistance was observed following the injection of nanomaterials, with values ranging between 30 and 50% under test conditions.

Lastly, following the approach described in document WO 2020/084378, conductive particles were synthesized within columns packed with sandy porous media. In this case as well, the electric resistance readings taken before and after the application of the method revealed a significant improvement in the conductive properties of the porous medium, with a reduction in electrical resistance of over 30%.

Of course, without prejudice to the principle of the present invention, the forms of embodiment and the implementation details may be extensively varied from those described and illustrated herein merely by way of non-limiting example, without however departing from the protection scope of the present invention as set out in the appended claims.

1. A system for applying electric fields into the subsoil, in particular for reclamation and requalification of contaminated sites, comprising:
a conductive element arranged in a drilling made in a subsoil portion;
a first electrically conductive material suitable for filling a gap generated between an outer wall of said conductive element and an inner wall of said drilling, so that said conductive element is at least partly in electrical contact with said first electrically conductive material;
a second electrically conductive material suitable for being injected into said subsoil portion so as to be in electrical contact with said conductive element and with said first electrically conductive material;
means suitable for supplying electric energy to said conductive element in order to generate an electric field between said conductive element and one or more subsoil portions located around said drilling.

2. The system according to claim 1, comprising injection and/or extraction means insertable, whether temporarily or permanently, into said drilling, and provided with first opening means suitable for injecting said second electrically conductive material into said subsoil portion and/or suitable for injecting into and/or extracting from said subsoil portion fluids, muds and/or colloidal suspensions.

3. The system according to claim 1, wherein said injection and/or extraction means comprise said conductive element, said conductive element being hollow and provided with second opening means suitable for injecting said second electrically conductive material into said subsoil portion and/or suitable for injecting into and/or extracting from said subsoil portion fluids, muds and/or colloidal suspensions.

4. The system according claim 2, wherein said injection and/or extraction means comprise at least one non-return valve suitable for preventing a backflow of said second electrically conductive material towards said injection and/or extraction means.

5. The system according to claim 1, wherein said conductive element is at least partly made of one or more of the following electrically conductive materials: metals, in particular steel, iron, copper or graphite; carbon materials; conductive polymers; conductive fabrics; conductive cements.

6. The system according to claim 1, wherein at least one longitudinal portion of said conductive element comprises an electrically non-conductive material.

7. The system according to claim 6, wherein said conductive element comprises first longitudinal portions comprising an electrically non-conductive material alternated with second longitudinal portions comprising an electrically conductive material.

8. The system according to claim 1, wherein said first electrically conductive material comprises a granular material having an average grain size greater than 0.1 mm and a hydraulic conductivity greater than 10⁻⁴ m/s.

9. The system according to claim 8, wherein said granular material comprises grains comprising one or more of the following materials: zerovalent iron; zerovalent copper; steel or other metals; graphite; coal; environmentally compatible conductive materials.

10. The system according to claim 1, wherein said first electrically conductive material comprises an impermeable or low-permeable compact material having an average grain size smaller than 10 mm and a hydraulic conductivity of less than 10⁻⁴ m/s.

11. The system according to claim 10, wherein said impermeable compact material comprises one or more of the following materials: clay; conductive cement; coal or graphite powder; metal powders; conductive resins; environmentally compatible conductive materials.

12. The system according to claim 1, wherein said second electrically conductive material comprises nanoparticles and/or microparticles having a size between 1 nm to 10 mm.

13. The system according to claim 12, wherein said nanoparticles and/or microparticles comprise one or more of the following materials: zerovalent iron; zerovalent copper; sulphides of iron or other conductive minerals or metals; graphene; graphite; coal; conductive cement.

14. A method for applying electric fields into the subsoil, in particular for reclamation and requalification of contaminated sites, comprising the steps of:
executing a drilling into a subsoil portion;
introducing within said perforation a conductive element;
filling with a first electrically conductive material a gap generated between an outer wall of said conductive element and an inner wall of said drilling in a such way that said conductive element is at least partly in electrical contact with said first electrically conductive material;
injecting into said subsoil portion a second electrically conductive material in a such way that it is in electrical contact with said conductive element and with said first electrically conductive material;
supplying electrical energy to said conductive element in order to generate an electric field between said conductive element and one or more subsoil portions located around said drilling.

15. The method according to claim 14, comprising the step of introducing into said gap, whether temporarily or permanently, a tubular device having first opening means through which said second electrically conductive material is injected into said subsoil portion and/or fluids, muds and/or colloidal suspensions are injected and/or extracted.

16. The method according to claim 14, wherein said conductive element is hollow and is provided with second opening means through which said second electrically conductive material is injected into said subsoil portion and/or fluids, muds and/or colloidal suspensions are injected into and/or extracted from said subsoil portion.

17. The method according to claim 14, wherein said first electrically conductive material is introduced into said drilling to form a single continuous layer, or it is introduced as multiple layers comprising different conductive materials or alternated by between non-conductive materials in order to focus said electric field on limited portions of said subsoil.

18. The method according to claim 14, wherein said second electrically conductive material is either injected in particle form or synthesized directly within said subsoil portion upon injection of liquid and/or solid precursors.

19. The method according to claim 14, wherein said second electrically conductive material is injected into fractures of said subsoil portion.

20. The system according claim 3, wherein said injection and/or extraction means comprise at least one non-return valve suitable for preventing a backflow of said second electrically conductive material towards said injection and/or extraction means.
